(19) United States
(12) Patent Application Publication
(10) Pub. No.: US 2010/0044278 A1
(43) Pub. Date: Feb. 25, 2010

(54) System and method for separation and handling of construction, demolition and garbage materials

(76) Inventor: Thomas B. Harmon, Odessa, FL (US)

Correspondence Address: WILLIAM E. JOHNSON, JR., 8823 KILRENNY DRIVE, SPRING, TX, 77379, US

(21) Appl. No.: 12/462,380

(22) Filed: Aug. 3, 2009

Related U.S. Application Data
(60) Provisional application No. 61/189,683, filed on Aug. 21, 2008.

(51) Int. Cl. B03B 7/00

(52) U.S. Cl. 209/3.1

(57) ABSTRACT

Refuse, waste material is loaded first into a shredder, the output of which is passed through a ferrous metal detector and then a non-ferrous metal detector, thereby removing most of the metal materials. The partially treated waste product is then fed into a separator tank at least partially filled with water, and made turbulent by the introduction of pressurized water and pressurized air to separate floatable materials from the non-floatable, heavy material such as concrete. The output of the separator tank, after separating the floatable materials, is then fed through a settlement tank, removing the remaining heavy slurry materials from the remaining lighter slurry of the waste material. As an option, the remaining lighter slurry waste material can be fed back into the separator tank for further processing.

### RELATED APPLICATIONS

This application relates to, and claims priority from U.S. Provisional Patent Application Ser. No. 61/189,683, filed Aug. 21, 2008, for SYSTEM AND METHOD FOR SEPARATING CONSTRUCTION AND DEMOLITION (C&D) MATERIALS.

### FIELD OF INVENTION

The invention relates, generally, to the separation and handling of the various components of refuse, waste materials such as rubbish, trash, debris, and garbage, and more specifically, to construction and demolition materials and to garbage materials collected on residential and commercial properties.

### DESCRIPTION OF ART

Construction and demolition (C&D) materials consist of the debris generated during the construction, renovation, and demolition of houses, apartments, buildings, roads, bridges and the like. C&D materials often contain bulky, heavy materials such as concrete, wood (from buildings), asphalt (from roads and roofing shingles), gypsum (the main component of drywall), metals, bricks, glass, plastics, salvaged building components (doors, windows, and plumbing fixtures), and trees, stumps, earth, and rock from clearing sites.

Many C&D materials have been recycled by industry. Recycling of C&D materials conserves landfill space, reduces the environmental impact of producing new materials, creates jobs, and can reduce the overall cost of new building projects. However, separation and reduction of C&D materials for recycling purposed has traditionally been expensive, labor intensive and time-consuming.

Residential and commercial garbage may have some of the same components as those found in C&D materials, but may also have glass bottles, plastic bottles, aluminum cans, food particles, paper and the like.

Some components of garbage have been recycled, by some people, but not all. The landfill sites continue to be overloaded, requiring more and more landfills.

It is therefore the principal object of this present invention to at least partially address the problems associated with the separation and handling of the various components of refuse and waste materials.

### BRIEF DESCRIPTION OF THE DRAWINGS

FIG. 1 is a block diagram of the system according to the invention;

FIG. 2A is an isometric view of the separation tank used in the system according to the invention;

FIG. 2B is a bottom view of the separation tank illustrated in FIG. 2A;

FIG. 2C is a side view of the separation tank illustrated in FIG. 2A;

FIG. 3A is an isometric view of the settlement tank used in the system according to the invention;

FIG. 3B is a side view of the settlement tank illustrated in FIG. 3A;

FIG. 3C is a bottom view of the settlement tank illustrated in FIG. 3A;

FIG. 3D is a graphic side view of the interior of the settlement tank illustrated in FIGS. 3A, 3B and 3C; and

FIG. 4 graphically illustrates the jets which are used to supply high pressure water in the separator tank according to FIGS. 2A, 2B and 2C of the invention.

### DETAILED DESCRIPTION OF THE PREFERRED EMBODIMENTS OF THE INVENTION

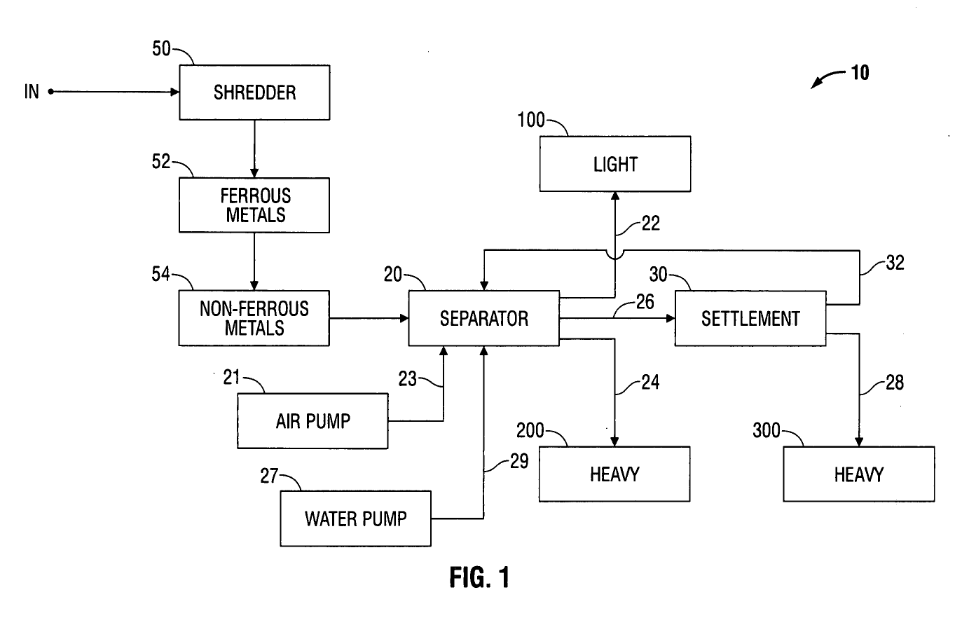

Referring now to FIG. 1, there is illustrated, in block diagram, the system 10 according to the invention in which the refuse/waste material, whether it be C&D materials, or garbage, or the like, is dumped from the “in” input location into the shredder 50. The shredder 50 is preferably of the conventional variable size type, sometimes referred to as a “(+) or (−)” type, for example a 3″, + or −1″. Depending upon the intended final use of the output product of the system 10, the shredder 50 can produce larger or smaller shreds.

The output of the shredder 50 is fed into a conventional ferrous metal detector 52 which uses the magnetic attraction of the ferrous materials to pick out and remove such ferrous materials from the mix.

The mix is also fed through a conventional non-ferrous metal detector 54, which uses eddy currents to pick out and remove such non-ferrous materials, for example, aluminum cans, from the mix. It is of no consequence whether the ferrous metal materials or the non-ferrous metal materials are first retrieved from the mix. After the ferrous metals and the non-ferrous metals are removed from the mix, the mix is then dumped into the separator tank 20.

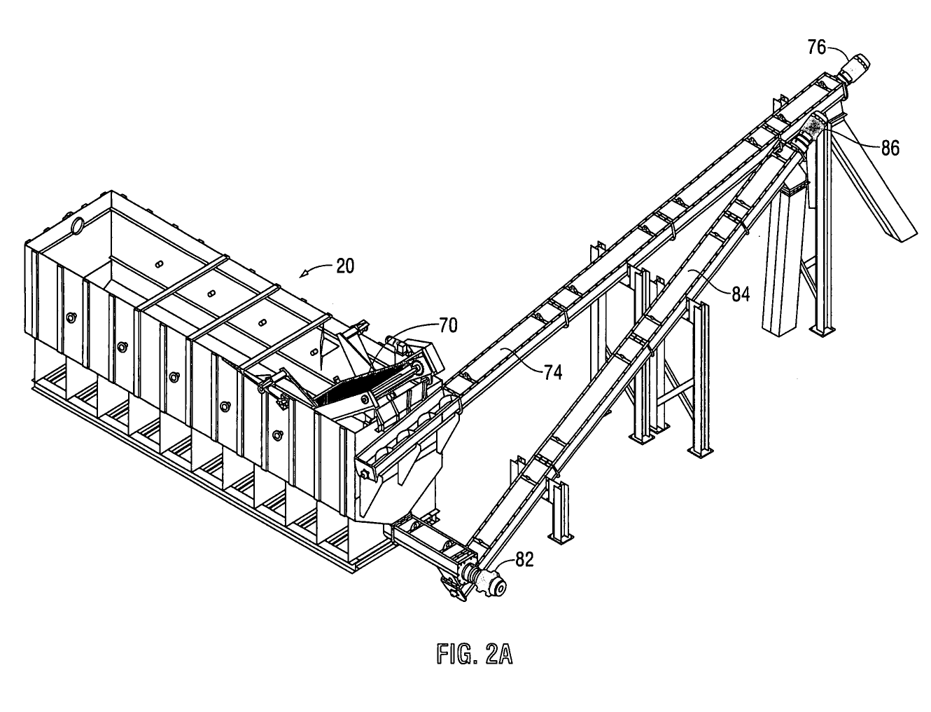

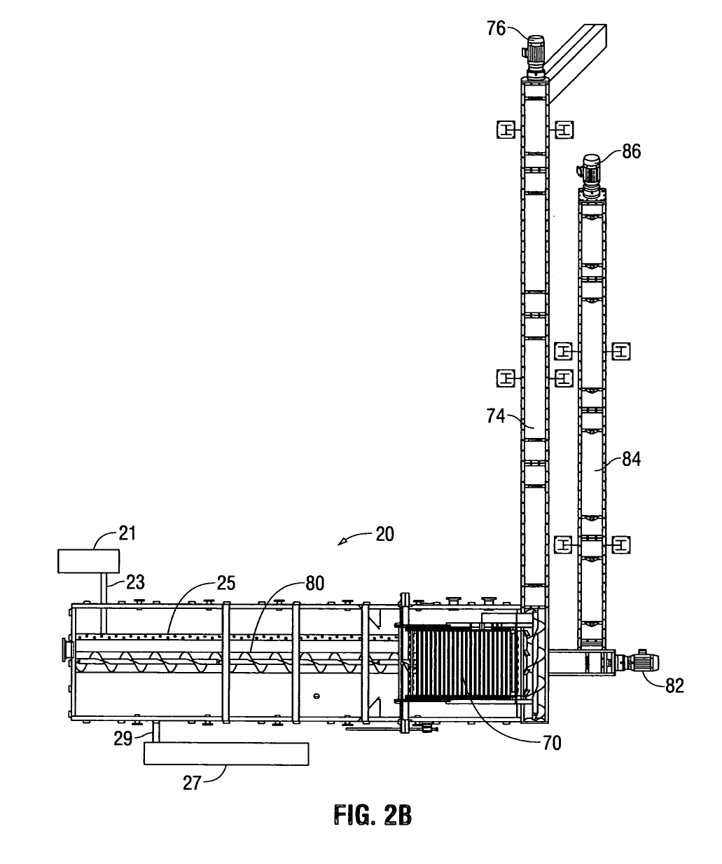

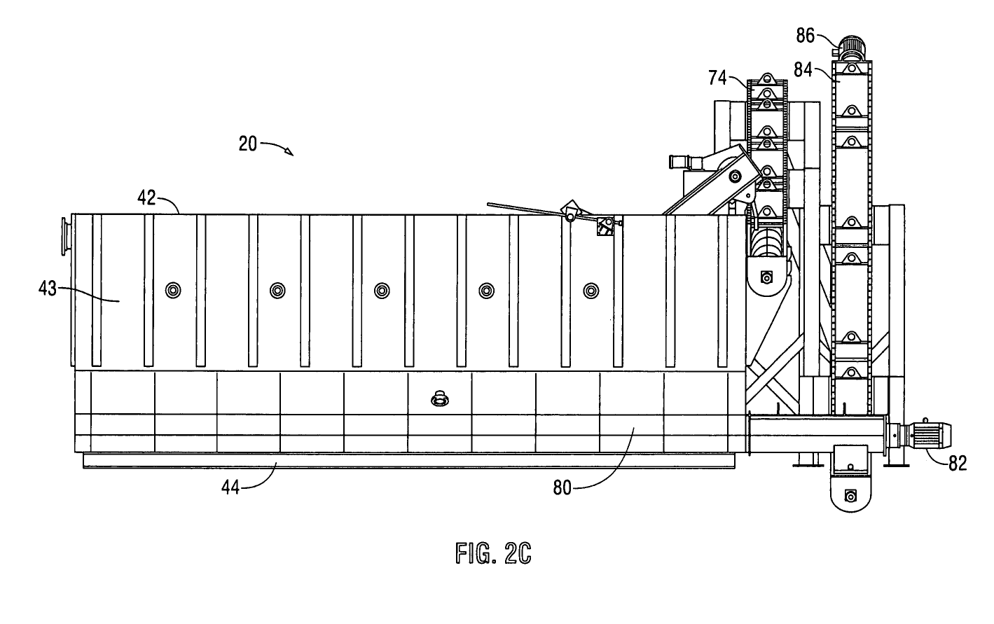

The output of air pump 21 is connected by a pressurized air line 23 to one or more air lines 25 (see FIG. 2B), preferably along the bottom of tank 20. The line or lines 25 preferably have a plurality of nozzles to create turbulence in the water-filled tank 20. In addition, nozzles in the interior sidewall of tank 20 are fed by the high pressure water pump 27 through water line 29 (see FIGS. 1 and 4) to the high pressure water jets 110 in FIG. 4 to create additional turbulence in the water-filled tank 20. The turbulence created in the water-filled tank 20 mimics the turbulence generated in whirlpool bath tubs, exemplified by Jacuzzi* (* JACUZZI is the registered trademark of Jacuzzi, Inc. Chino Hills, Calif.) brand hot tubs. The turbulent flow of the water helps to cause separation of the constituent parts of the waste material. The separator tank 20, described in greater detail hereinafter, preferably is filled with water and has a skimmer 70, illustrated in FIG. 2A, at or near the top surface of tank 20 which skims off the floating materials such as wood, which then exits along path 22 (see FIG. 1) which then is dumped into the “LIGHT” tank or storage bin 100. The light material in the bin 100, usually wood, can be used as a fuel source, or for various other purposes.

The heavier materials, for example, concrete, will settle onto the lower floor of the tank 20, which then exits the tank 20 along the exit path 24 (see FIG. 1) and then is dumped into the “HEAVY” tank or storage bin 200. The heavy material in the bin 200, usually stone or concrete, can be ground up as needed, and used in road paving materials.

The sludge-or slurry in the central elevation of the separation tank 20 exits the tank 20 along the exit path 26 and then is dumped into the settlement tank 30, the operation of which is described in greater detail hereinafter.

The settlement tank promotes the further settlement of the slurry material, causing the heavier materials to settle on the lower floor of the tank 30, which then exits the settlement tank 30 along the exit path 28 and is then dumped into the tank or bin 300. The material in the bin 300 can be further treated, for example, dried and ground up, and used for example, as fertilizer or as an additive mixed with sand or loose dirt to augment or strengthen the earth's surface where needed. The slurry materials in the top end of the settlement tank 30,.usually mostly water, can exit along the exit path 32 and be returned by gravity to tank 20 for further processing if desired.

Referring now to FIGS. 2A, 2B and 2C, there is illustrated in greater detail three (3) views of the separation tank 20. FIG. 2A illustrates an elevated, isometric view of the tank 20 having a skimmer 70 for removing the floating debris. FIGS. 2B and 2C illustrate the auger 80 located along the bottom side of the tank 20. The auger 80 is driven by motor 82. The heavy materials are moved by the auger 80 onto the roll-off 84 powered by motor 86, thus providing a portion of the exit path 24.

FIGS. 2A, 2B and 2C also illustrate the roll-off auger 74 which is used to remove the floating materials picked up by skimmer 70. The roll-off auger 74 is driven by motor 76.

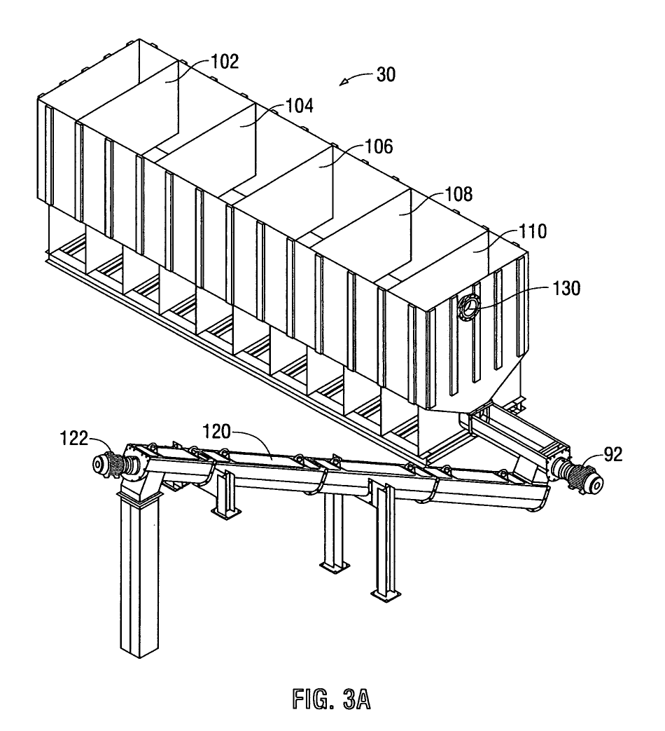

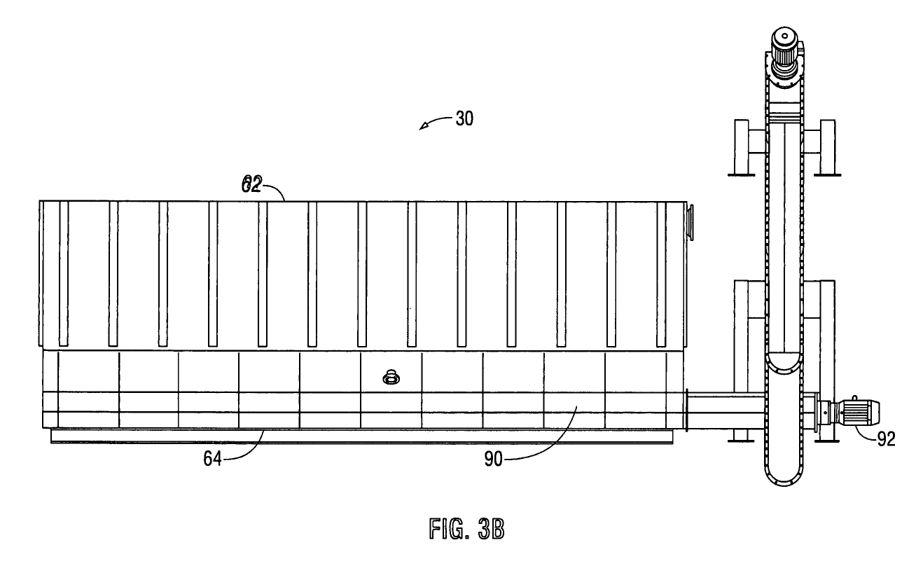

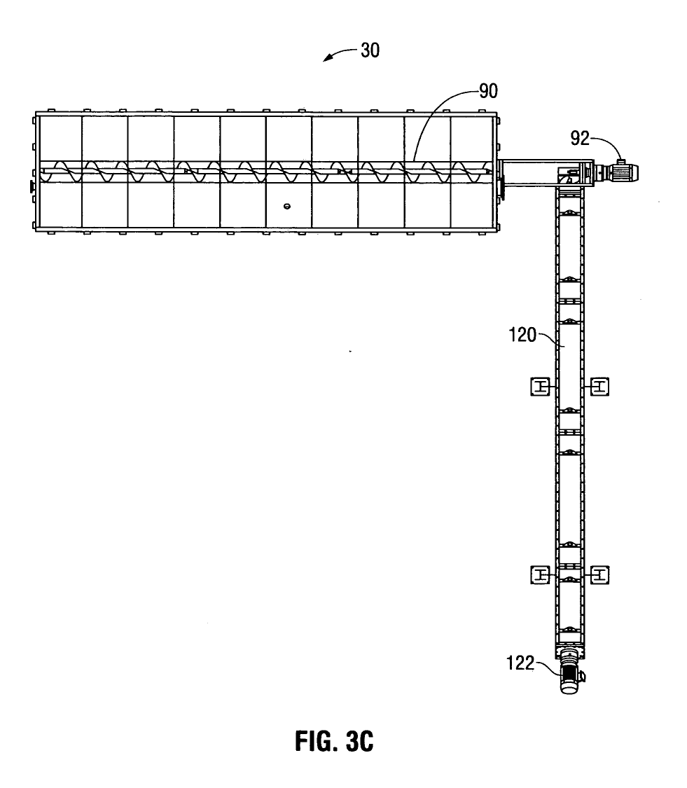

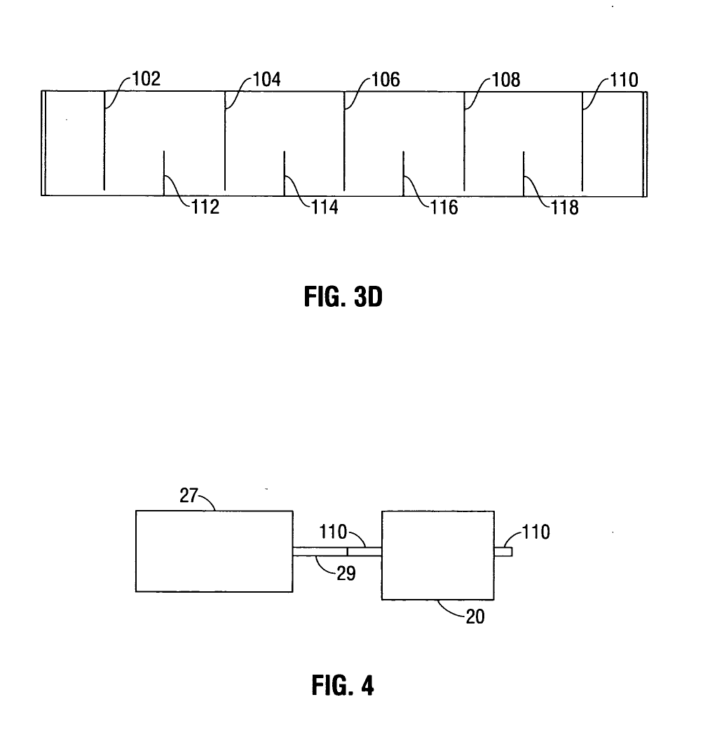

Referring now to FIGS. 3A, 3B, 3C and 3D, there is illustrated the settlement tank 30 in greater detail. The tank 30 in FIG. 3A has a plurality of baffles 102, 104, 106, 108 and 110, also illustrated in FIG. 3D. As illustrated, these longer baffles, for example, baffle 102, extend at their top ends up to the top of the tank 30, while extending in proximity to the floor of tank 30 which allows the slurry in tank 30 to flow thereunder. A plurality of shorter, lower baffles 112, 114, 116 and 118 extend at their lower ends to the floor of tank 30 but only about one-half of the distance towards the upper surface of the tank 30.

The fluid in tank 20, generally a slurry, is quite turbulent even as being pumped into tank 30. When the slurry contacts the baffles in tank 30, the slurry “calms down”, and begins the tortuous path over and under the baffles, and begins to settle out, creating a mostly water layer at the top and the heavier slurry layer at the bottom. In the operation of the settlement tank 30, as best illustrated in FIG. D, the fluid in the tank 30 will flow first under the lower end of baffle 102, then over the top of baffle 112, then under the lower end of baffle 104, etc., until finally emerging under the lower end of baffle 110 to allow the heavier slurry products to be moved onto the roll-off auger 120, illustrated in FIGS. 3A and 3C.

FIG. 3C illustrates an auger 90, powered by motor 92, located near the floor of tank 30. A rollover auger 120, is driven by motor 122.

FIG. 3A illustrates a flange 130 which can be used to allow the mostly water layer to return by gravity to tank 20 for further processing. The fluid path 28 is preferably slanted “downhill” to allow the gravity to return to tank 20.

In the operation of the system 10 as illustrated in FIGS. 1, 2A-2C, and 3A-3D, the refuse, waste materials are preferably dumped into the shredder 50 and then into the ferrous detector 52 and the non-ferrous detector 54, and then into the separator tank 20. The conventional metal detectors 52 and 54 are used with conventional metal removing equipment which removes most, if not all of the metal materials in the waste material being treated.

System 10 is utilized to recover key constituent components from such refuse, waste materials for recycling purposes. In a preferred embodiment, system 10 is utilized at the same location where the refuse, waste materials are collected and/or recovered, for example, a landfill facility. Alternatively, the refuse, waste materials can be delivered to the location of system 10 from offsite.

As illustrated in FIGS. 1, 2A-2C and 3A-3D, system 10 preferably comprises a separation tank 20 and a settlement tank 30. Tanks 20 and 30 can be formed of carbon steel or other like material. Separation tank 20 has a top end 42, a bottom end 44 and a middle section 43 between top end 42 and bottom end 44. Settlement tank 30 has a top end 62 and a bottom end 64.

In an illustrative embodiment the refuse, waste materials are initially collected by a truck (not illustrated). The truck can be an excavator, backhoe or the like. The truck is utilized to transport the refuse, waste (not illustrated) into separation tank 20 for initial deposit or offloading. In a specific embodiment, the refuse/waste materials are shredded, for example, in a shredder 50 prior to being uploaded into separation tank 20.

In operation, separation tank 20 is at least partially filled with highly turbulent water. The refuse, waste material entering separation tank 20 will likely include a mix of shredder waste. Upon entering separation tank 20, the heaviest waste material, for example, heavy concrete, will generally sink and/or settle at or near bottom end 44, while the lightest weight refuse, for example, light or otherwise floatable wood will generally float and/or rise to or near top end 42. A remaining portion of the waste material for example, shreddable or powered drywall, and free or/loose dirt, will generally mix with the water to form a slurry that is present throughout middle section 43. Sometimes the slurry is also found in the top end 42 and the bottom end 44, and may require additional treatment in order to settle out into its key constituent components for recycling purposes.

Separation tank 20 preferably includes one or more angled high pressure jets 110 (FIG. 4) which are powered by one or more water pumps 27. Jets 110 are preferably positioned in multiple locations surrounding the interior of separation tank 20. These turbulent conditions created by the jets 110, coupled with the turbulent flow resulting from the one or more air line 25 nozzles, result in the unseparated debris, which primarily consists of debris in middle section 43, being at least partially separated into its key constituent components. For example, the wood will separate out and float to top end 42, while the stone and concrete will separate out and settle to bottom end 44.

Separation tank 20 preferably includes a skimmer 70 positioned at or near top end 42. Skimmer 70 moves back and forth across top end 42 of separation tank 20 and collects components of refuse, waste that have floated to or near the water surface. Skimmer 70 deposits the waste, refuse in a collection for holding until the debris can be delivered by a first roll-off auger 74. First roll-off auger 74 is powered by motor 76.

Separation tank 20 preferably includes a separation tank auger 80 located at or near bottom end 44. Separation tank auger 80 is driven by motor 82. In a preferred embodiment, separation tank auger 80 spins and rotates to catch and push heavier components that have settled to bottom end 44 towards a second roll-off auger 84. Second roll-off auger 84 delivers the collected refuse, waste to a roll-off area. Second roll-off auger 84 is powered by motor 86.

In an illustrative embodiment, the slurry material in separation tank 20 is delivered by gravity to settlement tank 30 for additional processing. As an option, however, the slurry material can be pumped to settlement tank 30 via a pump (not illustrated). Flow from tank 20 to settlement tank 30 can be controlled by a flow valve (not illustrated). The slurry material can also, if desired, be directed back to separation tank 20 for reprocessing. The slurry material is preferably allowed to move by gravity to separation tank 20. The amount of slurry material that is delivered to separation tank 20 and/or settlement tank 30 can be controlled by the user as desired.

Settlement tank 30 preferably includes a settlement tank auger 90 located at or near bottom end 64. Auger 90 is driven by motor 92. In an illustrative embodiment, settlement tank auger 90 spins and rotates as it contacts the refuse, waste material.

A plurality of upper baffles (see FIG D), individually numbered as baffles 102, 104, 106, 108 and 110, extend downward from top end 62, and upward from bottom end 64, within settlement tank 30. The upper and lower baffles direct the flow of the refuse, waste material, along a tortuous path within settlement tank 30. The baffles also engage against the refuse, waste material and promote the settlement of heavier and lighter components.

The heavier components settle out of the slurry material onto or near the bottom end 64 of settlement tank 30. These heavier components are pushed in the direction of third roll-off auger 120, and are delivered out of settlement tank 30 and to a roll- off area.

The lighter components from the slurry material exit settlement tank 30 and are returned, if desired, to separation tank 20 for reprocessing.

In the drawings and specification, there has been disclosed and described typical preferred illustrative embodiments of the invention, and although specific terms are employed, the terms are used in a descriptive sense only and not for purposes of limitation. It will be apparent that various modifications and changes can be made within the spirit and scope of the invention as described in the foregoing specification. Accordingly, the invention is therefore to be limited only by the scope of the appended claims.

What is claimed is:

1. A method for processing waste materials to allow recycling of the constituent parts of such waste materials, comprising the steps of:
shredding the waste materials;
removing any metal constituents from said shredded materials;
introducing pressurized air into a separation tank of water containing the shredded waste material;
separating the floatable constituents of said shredded materials from the non-floatable constituents of said shredded materials; and
allowing the remaining lighter slurry constituents of said waste materials to settle apart from the heavier slurry constituents of such waste materials.

2. The method according to claim 1, comprising at least one additional step of moving the removed metal constituents of said waste material to one or more locations to allow the recycling of such metal constituents.

3. The method according to claim 2, comprising the steps of removing the non-ferrous metal constituents to a first location and the ferrous metal constituents to a second location.

4. The method according to claim 1, comprising the steps of moving the floatable constituents of said waste material to a first location and the non-floatable materials to a second location to allow the recycling of said floatable materials and the separate recycling of said non-floatable materials.

5. The method according to claim 4, wherein said floatable materials comprise wood.

6. The method according to claim 5, wherein said floatable materials are recycled to be used as a source of fuel.

7. The method according to claim 4, wherein said non-floatable materials comprise concrete.

8. The method according to claim 4, wherein said non-floatable materials are recycled to be used as a road paving material.

9. A method for processing waste materials to allow recycling of the constituent parts of such waste materials, comprising the steps of:
shredding the waste materials;
removing any metal constituents from said shredded materials;
introducing pressurized water through one or more jets into a separation tank of water containing the shredded waste material;
separating the floatable constituents of said shredded materials from the non-floatable constituents of said shredded materials; and
allowing the remaining lighter slurry constituents of said waste materials to settle apart from the heavier slurry constituents of such waste materials.

10. The method according to claim 9, comprising at least one additional step of moving the removed metal constituents of said waste material to one or more locations to allow the recycling of such metal constituents.

11. The method according to claim 10, comprising the steps of removing the non-ferrous metal constituents to a first location and the ferrous metal constituents to a second location.

12. The method according to claim 9, comprising the steps of moving the floatable constituents of said waste material to a first location and the non-floatable materials to a second location to allow the recycling of said floatable materials and the separate recycling of said non-floatable materials.

13. The method according to claim 12, wherein said floatable materials comprise wood.

14. The method according to claim 13, wherein said floatable materials are recycled to be used as a source of fuel.

15. The method according to claim 12, wherein said non-floatable materials comprise concrete.

16. The method according to claim 12, wherein said non-floatable materials are recycled to be used as a road paving material.

17. A method for processing waste materials to allow recycling of the constituent parts of such waste materials, comprising the steps of:
shredding the waste materials;
removing any metal constituents from said shredded materials;
introducing pressurized air into a separation tank of water containing the shredded waste material;
introducing pressurized water through one or more jets into a separation tank of water containing the shredded waste material;
separating the floatable constituents of said shredded materials from the non-floatable constituents of said shredded materials; and
allowing the remaining lighter slurry constituents of said waste materials to settle apart from the heavier slurry constituents of such waste materials.

18. The method according to claim 17, comprising at least one additional step of moving the removed metal constituents of said waste material to one or more locations to allow the recycling of such metal constituents.

19. The method according to claim 18, comprising the steps of removing the non-ferrous metal constituents to a first location and the ferrous metal constituents to a second location.

20. The method according to claim 17, comprising the steps of moving the floatable constituents of said waste material to a first location and the non-floatable materials to a second location to allow the recycling of said floatable materials and the separate recycling of said non-floatable materials.

21. The method according to claim 20, wherein said floatable materials comprise wood.

22. The method according to claim 21, wherein said floatable materials are recycled to be used as a source of fuel.

23. The method according to claim 20, wherein said non-floatable materials comprise concrete.

24. The method according to claim 20, wherein said non-floatable materials are recycled to be used as a road paving material.

25. A system for treating waste materials by dividing such waste materials into constituent parts, comprising:
a shredder, having an inlet into which waste materials may be fed, and an outlet for releasing shredded waste materials;
a metal detector system for detecting and removing ferrous and non-ferrous metals from said released shredded waste materials; and
a separator tank, at least partially filled with water, having an inlet for receiving waste materials from said metal detector system and also having a pressurized air system for causing turbulence in the water separating the floatable waste materials from the non-floatable waste materials, thereby allowing the recycling of said floatable waste materials and the separate recycling of said non-floatable waste materials.

26. The system according to claim 25, comprising in addition thereto, a settlement tank having an input connected to an output from said separator tank, whereby the lighter waste materials are settled out from the heavier waste materials residing in said settlement tank.

27. The system according to claim 26, wherein waste materials residing in said settlement tank may only travel from one end of the settlement tank to the other end of the settlement tank solely by traversing a plurality of baffles situated in said settlement tank.

28. The system according to claim 26, wherein said waste material comprises garbage.

29. The system according to claim 26, wherein said waste material comprises rubbish.

30. The system according to claim 26, wherein said waste material comprises construction debris.

31. The system according to claim 26, wherein said waste material comprises demolition debris.

32. A system for treating waste materials by dividing such waste materials into constituent parts, comprising:
a shredder, having an inlet into which waste materials may be fed, and an outlet for releasing shredded waste materials;
a metal detector system for detecting and removing ferrous and non-ferrous metals from said released shredded waste materials; and
a separator tank, at least partially filled with water, having an inlet for receiving waste materials from said metal detector system and also having a pressurized water jet system for causing turbulence in the water separating the floatable waste materials from the non-floatable waste materials, thereby allowing the recycling of said floatable waste materials and the separate recycling of said non-floatable waste materials.

33. The system according to claim 32, comprising in addition thereto, a settlement tank having an input connected to an output from said separator tank, whereby the lighter waste materials are settled out from the heavier waste materials residing in said settlement tank.

34. The system according to claim 33, wherein waste materials residing in said settlement tank may only travel from one end of the settlement tank to the other end of the settlement tank solely by traversing a plurality of baffles situated in said settlement tank.

35. The system according to claim 33, wherein said waste material comprises garbage.

36. The system according to claim 33, wherein said waste material comprises rubbish.

37. The system according to claim 33, wherein said waste material comprises construction debris.

38. The system according to claim 26, wherein said waste material comprises demolition debris.

39. A system for treating waste materials by dividing such waste materials into constituent parts, comprising:
a shredder, having an inlet into which waste materials may be fed, and an outlet for releasing shredded waste materials;
a metal detector system for detecting and removing ferrous and non-ferrous metals from said released shredded waste materials; and
a separator tank, at least partially filled with water, having an inlet for receiving waste materials from said metal detector system and also having a pressurized air system, as well as a pressurized water jet system for causing turbulence in the water separating the floatable waste materials from the non-floatable waste materials, thereby allowing the recycling of said floatable waste materials and the separate recycling of said non-floatable waste materials.

40. The system according to claim 39, comprising in addition thereto, a settlement tank having an input connected to an output from said separator tank, whereby the lighter waste materials are settled out from the heavier waste materials residing in said settlement tank.

41. The system according to claim 40, wherein waste materials residing in said settlement tank may only travel from one end of the settlement tank to the other end of the settlement tank solely by traversing a plurality of baffles situated in said settlement tank.

42. The system according to claim 40, wherein said waste material comprises garbage.

43. The system according to claim 40, wherein said waste material comprises rubbish.

44. The system according to claim 40, wherein said waste material comprises construction debris.

45. The system according to claim 40, wherein said waste material comprises demolition debris.
